(19) United States
(12) Patent Application Publication
(10) Pub. No.: US 2016/0053821 A1
(43) Pub. Date: Feb. 25, 2016

(54) CLAW-TYPE COUPLING WITH RADIALLY DISPLACEABLE FINGERS

(71) Applicant: ZF Friedrichshafen AG, Friedrichshafen (DE)

(72) Inventor: Daniel WOLF, Friedrichshafen (DE)

(21) Appl. No.: 14/807,074

(22) Filed: Jul. 23, 2015

(30) Foreign Application Priority Data
Aug. 19, 2014 (DE) 10 2014 216 376.5

(51) Int. Cl. F16D 11/14

(52) U.S. Cl. CPC F16D 11/14

(57) ABSTRACT

A coupling with a first coupling half (202) and a second coupling half (102, 302, 402). The first coupling half (202) is designed to be rotationally fixedly connected with a first shaft. The second coupling half (102, 302, 402) is designed to be rotationally fixedly connected with a second shaft. The first coupling half (202) can displace a displaceable portion (106, 306, 406) when the first coupling half (202) and the second coupling half (102, 302, 402) are moved toward one another. The displaceable portion (106, 306, 406) of the second coupling half (102, 302, 402) is designed to engage with the second coupling half (202) in a form fit, rotationally fixed connection when the first coupling half (202) and the second coupling half (102, 302, 402) are moved toward one another. The displaceable portion (106, 306, 406) can be displaced primarily in the radial direction.

This application claims priority from German patent application serial no. 10 2014 216 376.5 filed Aug. 19, 2014.

### FIELD OF THE INVENTION

The invention concerns a coupling.

### BACKGROUND OF THE INVENTION

From the state of the art, such as Roloff/Matek “Machine Elements: Standardization, Calculation, Design (2009), claw clutches are known. During the engagement operation of a claw clutch, there is the danger of a so-called tooth-on-tooth-position. Herein, the fingers or teeth, respectively, of a first clutch half meet the fingers or teeth, respectively, of a second clutch half instead of meshing with the spaces between the fingers or teeth, respectively. A tooth-on-tooth-position prevents engagement of the claw clutch and therefore it interferes with a proper operation.

A claw coupling in which a tooth-to-tooth-position cannot occur is known from the publication DE 10 2010 04 14 18 A1 This publication teaches a claw coupling with elastic teeth. By displacing the elastic teeth from the fixed claw, a positive fit results.

The fixed claw and the displaceable teeth are positioned in the torque flow of the coupling. This places high demands on the fixation of the elastic teeth. If higher torques need to be transferred, it becomes very difficult to meet these requirements with axially displaceable teeth.

### SUMMARY OF THE INVENTION

The object of the invention is to provide a coupling that overcomes the disadvantages of the known prior art. In particular, a claw coupling needs to be designed where tooth-to-tooth-positions are prevented from occurring, so that larger torques can be transferred.

This object is solved with a coupling as described below.

This coupling is preferably disengageable or rather shiftable. This means that the coupling can be disengaged during the operation, meaning that it can be changed from an engaged condition to a disengaged condition. The closed condition is a state which allows the coupling to transfer torque from a first shaft to a second shaft and the open condition is a state in which such a transfer of a torque is not possible.

The coupling as usual is disengaged or engaged by means of an actuator which can be operated electrically or hydraulically. It is also possible to combine the actuator with a spring so that the actuator works against a spring force created by the spring. The coupling is herein disengaged by the actuator and engaged by means of the spring, or is engaged by the actuator and disengaged by the spring.

The coupling comprises a first coupling half and a second coupling half. The first coupling half is designed to be connected to a first shaft in a rotationally fixed manner. The second coupling half is designed to be connected to a second shaft in a rotationally fixed manner. Preferably, the rotational axis of the first shaft is the same as the rotational axis of the second shaft. The first coupling half and the second coupling half can be rotated in common about the rotational axis, if the first coupling half, connected to the first shaft, and the second coupling half, connected to the second shaft, are connected to each other in a rotationally fixed manner.

The first coupling half and the second coupling half can be moved towards each other. The movement of the first coupling half towards the second coupling half is equal to relative movement of the first coupling half and the second coupling half in reference to each other, wherein the distance between the first coupling half and the second coupling half is reduced. Thus, the first coupling half and the second coupling half move towards each other.

This relative movement represents translational movement, preferably in the axial direction, meaning along the rotational axes of the first shaft, the second shaft, the first coupling half, and the second coupling half. During shifting movement of the first coupling half and the second coupling half, the first coupling half moves in the direction of the second coupling half and/or the second coupling half moves in the direction of the first coupling half. That means that just the first coupling half, just the second coupling half, or both of the coupling halves are being moved.

The shift movement of the first part and the second part allows the engagement of the coupling. If the first coupling half and the second coupling half are moved towards each other, a form fit occurs—possibly after a following rotation of the first coupling half in reference to the second coupling half—and thus a rotationally fixed connection of the first coupling half and the second coupling half, and therefore also between the first shaft and the second shaft. The coupling gets disengaged through separating the first part and the second part, that is by relative movement of the two coupling halves in the opposite direction of the movement during the shift towards each other. When the coupling is disengaged, the first coupling half and the second coupling half, therefore also the first shaft and the second shaft can rotate opposite each other.

The second coupling half has at least one displaceable portion, The first coupling half, or rather at least a portion of the first coupling half can displace the displaceable portion of the second coupling half, if the first coupling half and the second coupling half are pushed together. The area of the first coupling half displaces the displaceable portion of the second coupling half, as the displaceable portion of the second coupling half is pushed aside by the area of the first coupling half. At the time when the area of the first coupling half has displaced the displaceable portion of the second coupling half, the area of the first coupling half is positioned where previously at least a part of the displaceable portion of the second coupling half was located. The displacement of the displaceable portion of the second coupling half happens preferably by contact between the area of the first coupling half and the displaceable portion of the second coupling half, so that the area of the first coupling half creates a force on the displaceable portion of the second coupling half which leads to a displacement of the displaceable portion of the second coupling half.

The condition “when the first coupling half and the second coupling half are pushed towards each other” is necessary, but not good enough. This means that the displacement of the displaceable portion of the second coupling half through the area of the first coupling half requires that the first coupling half and the second coupling half are pushed towards each other. If the first coupling half and the second coupling half are pushed towards each other there is not necessarily a displacement of the displaceable portion. In fact, the displacement of the displaceable portion can be, based on the design of the coupling, dependent of the position of the first coupling half and relative to the second coupling half. Therefore, a position at least exists for the first coupling half in relationship to the second coupling half where the displaceable portion of the second coupling half is not displaced by the area of the first coupling half when the first coupling half and the second coupling half are pushed towards each other. Furthermore, embodiments of the coupling are possible where the area of the first coupling half always, meaning independent from the position of the first coupling half relative to the second coupling half, displaces a displaceable portion of the second coupling half when the first coupling half and the second coupling half are pushed towards each other.

The displaceable portion of the second coupling half is designed to achieve with the first coupling half, a form-fit, rotationally fixed connection when the first coupling half and the second coupling half are pushed towards each other. To the contrary, also the area of the first coupling half can be designed to achieve with the second coupling half a rotationally fixed connection when the first coupling half and the second coupling half are pushed towards each other.

A so-called form fit connection only occurs when the first coupling half and the second coupling half were pushed towards each other. But it is also possible that the first coupling half and the second coupling half were pushed towards each other and the form fit connections did not occur. However and preferably, at least a form fit connection occurs between the area of the first coupling half and the second coupling half when the first coupling half and the second coupling half where pushed towards each other and the first coupling half and the second coupling half where located against each other thereafter. The form fit connection does not occur right away, but after rotation of the two coupling halves.

Preferably, the area of the first coupling half and the displaceable portion of the second coupling half are designed in a way that a form fit connection between the area of the first coupling half and the displaceable portion of the second coupling half can be achieved when the first coupling half and the second coupling half are pushed towards each other. But the creation of such a form fit connection depends on the position of the first coupling half relative to the second coupling half. In particular, positions of the first coupling half can exist, relative to the second coupling half, where the form fit connection can occur in the area of the first coupling half with the second coupling half between the area of the first coupling half and an area of the second coupling half, which differs from the displaceable portion of the second coupling half, like when the displaceable portion during the movement towards each other of the first coupling half and the second coupling half was displaced. Preferably, this mentioned area of the second coupling half is also a displaceable portion, meaning that the mentioned area is designed as being displaceable by the portion of the first coupling half.

The displaceable portion has at least a first effective area. It is designed to get in contact with an additional effective portion of the first coupling half when the first coupling half and the second coupling half are moved towards each other, so that a form fit connection between the two effective areas is created. Preferably, the displaceable portion of the second coupling half has also a second effective area which is designed to establish the contact with the first coupling half when the first coupling half and the second coupling half are moved together. By way of the contact of the second effective area and the first coupling half, the displaceable portion of the second coupling half is displaced.

The displaceable portion of the second coupling half is preferably designed as a flexible finger of a claw coupling. This finger is displaced by a finger of the first coupling half if a tooth-on-tooth condition occurs between the two fingers.

In accordance with the invention, the displaceable portion of the second coupling half is mainly displaced in the radial direction. Mainly radially means that the displaceable portion of the second coupling half is displaced in a direction which, in reference to the rotational axis of the first shaft, the second shaft, the first coupling half, and the second coupling half, is inclined by more than 45°. The direction of the movement is therefore, in reference to the rotational axis, an angle of more than 45°.

The direction of the movement of the displaceable portion of the second coupling half can change during the displacement of the displaceable portion. This happens approximately at the time when the displaceable portion is rotatable positioned. In this case, the displaceable portion of the second coupling half is mainly displaced in the radial direction in each position which it might assume during the displacement. In particular, the displaceable portion of the second coupling half does not assume a position where the displacement happens mainly in the axial direction, meaning a direction which is less than 45° with reference to the rotation axis.

By the mainly radial displacement of the displaceable portion of the second coupling half, the displaceable portion is particularly resilient. In particular, the displaceable portion is especially resilient with reference to a torque which is present in the displaceable portion, which is transferred by means of the coupling of the first shaft to the second shaft.

Preferably, the displaceable portion of the second coupling half can be displaced in the radial direction. This means that the displaceable portion of the second coupling half is orthogonally displaced in reference to the rotational axis of the first shaft, the second shaft, the first coupling half, and the second coupling half.

In a preferred, further embodiment, a resetting force has an effect on the displaceable portion of the second coupling half. The reselling force acts against the displacement of the displaceable portion of the second coupling half. If the coupling is disengaged, meaning that the first coupling half and the second coupling half are moved away from each other, the resetting force causes that the displaceable portion returns to its original position, meaning the position which the displaceable portion had taken prior to the displacement.

The resetting force can be created in different ways. In a further, preferred embodiment, the second coupling half is designed as one piece. This applies in particular to the displaceable portion of the second coupling half. The displaceable portion and the remaining, second coupling half are therefore just one piece. If the displaceable portion of the second coupling half displaced, it creates a deformation of the second coupling half. The coupling is designed in a way that this deformation is elastic. During the deformation, the above mentioned resetting force is applied simultaneously. A mechanical configuration which would make the displaceable portion of the second coupling half flexible in reference to the remaining second coupling half is not required here. It creates the advantage of an additional, increase stability of the displaceable portion of the second coupling half.

As an alternative, the second coupling half can be designed as a multi part. Hereby, a fitting key creates the displaceable area of the second coupling half. The second coupling half has also a groove into which the fitting key is inserted. The fitting key is radially elasticly supported and therefore movable in the radial direction. The resetting force is preferably created by a spring which is positioned in such a way that it acts against movement of the fitting key in the groove.

### BRIEF DESCRIPTION OF THE DRAWINGS

Embodiments of the invention are shown in the drawings. Hereby, matching reference numbers mark the same or functionally same characteristics. It shows a detail:

FIG. 1a and FIG. 1b an inner coupling half of a claw coupling with radially displaceable fingers;

FIG. 2a and FIG. 2b and outer coupling half of such coupling;

FIG. 3a and FIG. 3b a one-piece designed inner coupling half; and

FIG. 4a and FIG. 4c a one-piece designed inner coupling half with a reinforcement element.

### DETAILED DESCRIPTION OF THE PREFERRED EMBODIMENTS

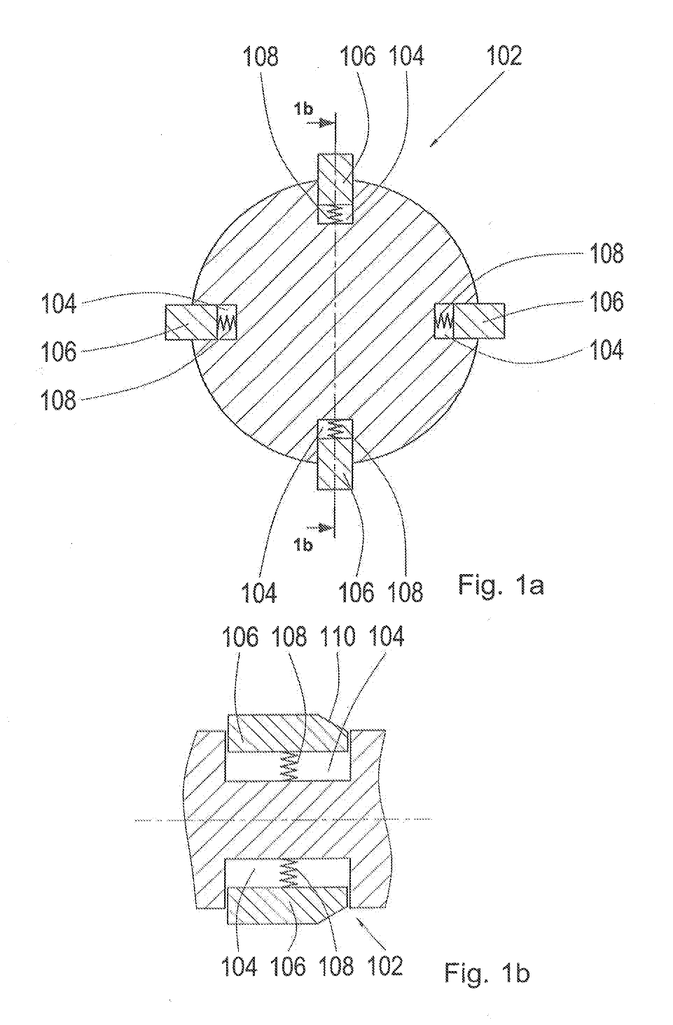

FIGS. 1a and 1b show the same inner coupling half 102, FIG. 1a shows a cross-section. FIG. 1b shows a longitudinal section 1b-1b.

The coupling half 102 is provided with axially extending grooves 104. A fitting key 106 is inserted into each groove 104. The fitting keys 106 can be moved in the grooves 104 in the radial direction.

Above the, the springs 108 are located in the grooves 104. The springs 108 are each braced between a groove 104 and a fitting key 106. The springs 108 therefore push each fitting key 106 out of the groove 104. Thus, the springs 108 act against pushing on the fitting keys 106 into the groove 104.

The fitting keys 106 have beveled surfaces 110.

The rotational axis of the inner coupling half 102 corresponds with the illustrated center line in FIG. 1b.

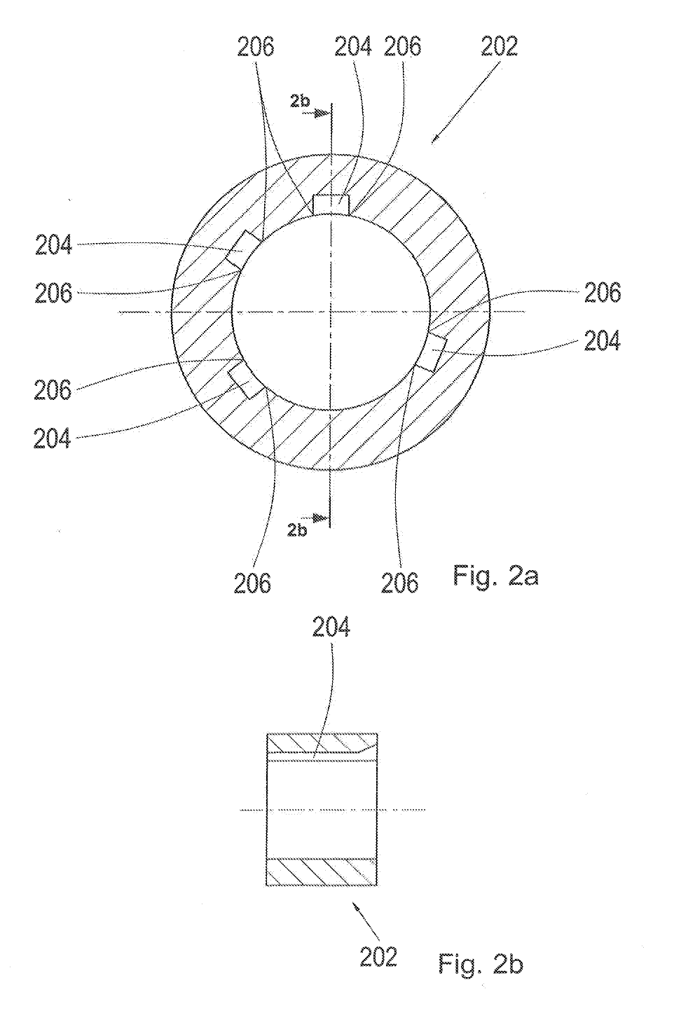

The related outer coupling half 202 is shown in FIGS. 2a and 2b. A cross section is shown in FIG. 2a, a longitudinal section 2b-2b in FIG. 2b.

The outer coupling half 202 has axially extending groove s 204. If the inner coupling half 102 and the outer coupling half 202 are pushed towards each other, meaning that the inner coupling half 102 is moved into the outer coupling half 202, the fitting keys 106 can engage with the groove s 204 of the outer coupling half. Thus, a form fit, rotationally fixed connection is created between the inner coupling half 102 and the output coupling half 202.

During the movement of the inner coupling half 102 in the outer coupling half 202, it may happen that the fitting keys 106 hit the areas 206 of the outer coupling half 202 extending between two grooves 204. Commonly known claw couplings would then be blocked and it would not be possible to move the inner coupling half 102 into the outer coupling half 202.

However, the fitting keys 106 have beveled surfaces 110. If the beveled surfaces 110 contact the areas 206, the fitting keys 106 are pushed into the grooves 104 of the inner coupling half 102, against the force of the springs 108. This eliminates the blocking and makes it possible to move the inner coupling half 102 into the outer coupling half 202.

A form fit connection between the inner coupling half 102 and the outer coupling half 202 is established when the inner coupling half 102 and the outer coupling half 202 are rotated against each other thereafter, until the fitting keys 106 and the grooves 204 of the outer coupling half 202 are aligned. Due to the force of the previously preloaded springs 108, the fitting keys 106 are then pressed into the grooves 204 of the outer coupling half 202. Thus, a form fit connection is created between the inner coupling half 102 and the outer coupling half 202.

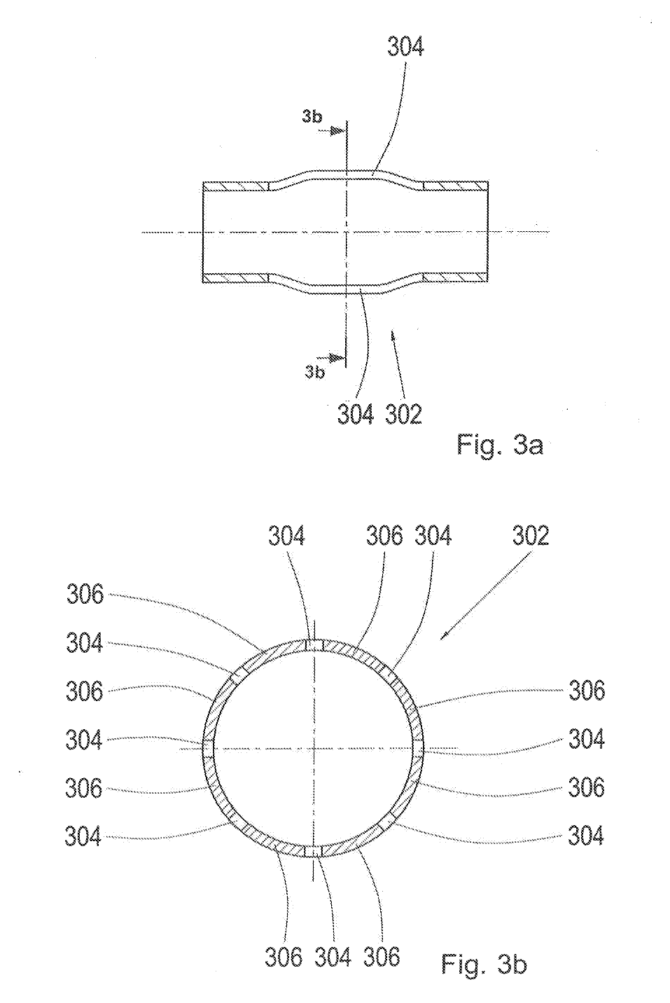

An integrally designed inner coupling half 302 is presented in FIG. 3a. A cross section 3b-3b of the inner coupling half 302 is shown in FIG. 3b.

The inner coupling half 302 is designed as a hollow cylindrically shaped pipe section. In it, axially extending recesses 304 are provided. Extending between these recesses 304 are strips 306 which are bent axially outward. The strips 306 form displaceable portions, which can be pushed radially inward. Hereby, an elastic deformation takes place. The displacement of the strips 306 inward is thus also reversible.

Fingers of the outer coupling half, not shown in FIGS. 3a and 3b, can mesh with the recesses 304. Thus, a form fit connection is created between the outer coupling half and the inner coupling half 302.

In order to engage the coupling, the outer clutch half and the inner coupling half 302 are pushed together. Depending on the position on the position of the two coupling halves with respect to each other, the fingers of the outer coupling engage in the recesses 304 or they hit on the strips 306, The latter causes displacement of the strips 306. In this case, the fingers of the outer coupling half engage in the recesses 304 when the outer coupling half and the inner coupling half 302 are then rotated against each other. Then the previously displaced strips 306 return into their original position.

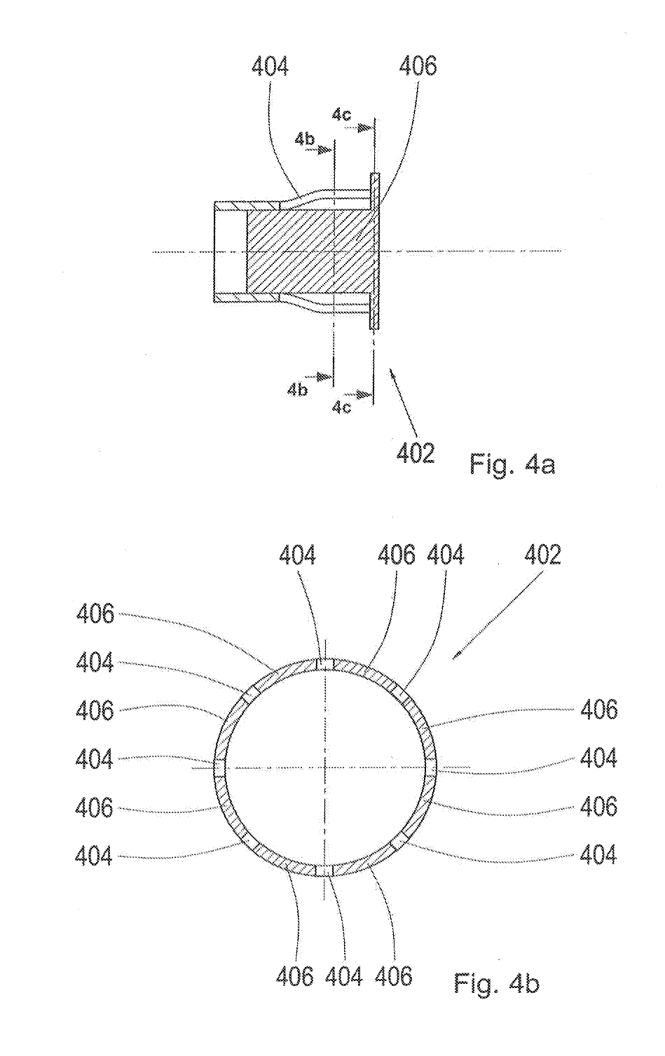

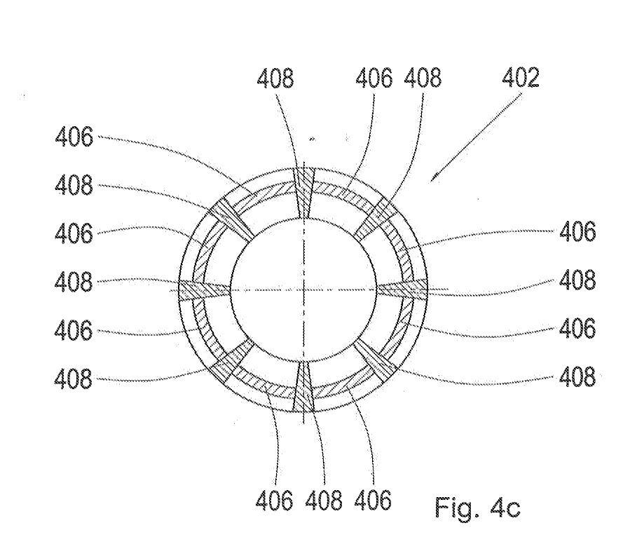

Another integrally designed inner coupling half 402 is shown in FIGS. 4a to 4c with cross-sections 4b-4b and 4c-4c. Just like the coupling half 302 of FIGS. 3a and 3b, the inner coupling half 402 as shown in FIGS. 4a to 4c is designed as a hollow cylindrically shaped pipe section.

The strips 406, bent radially outward and which run axially between the recesses 404 are here positioned, however, at one end of the pipe. This would cause stability problems. Thus, the inner coupling half 402 has a strengthening element 407. Teeth 408 of the strengthening element 407 engage with the recesses 404 and thereby ensure that the strips 406 can be support next to each other via the teeth 408 in the circumferential direction. The flexibility of the strips 406 in the radial direction hereby remains.

### REFERENCE CHARACTERS

102 Inner Coupling Half
104 Groove
106 Fitting key
108 Spring
110 Beveled Surface
202 Outer Coupling Half
204 Groove
206 Area
302 Inner Coupling Half
304 recess
306 Strip
402 inner Coupling Half
404 recess
406 Strip
407 Strengthening Element
408 Tooth

1-5. (canceled)

6. A coupling comprising:
a first coupling half (202),
a second coupling half (102, 302, 402),
the first coupling half (202) being connected to a first shaft in a rotationally fixed manner, and the second coupling half (102, 302, 402) being connected to a second shaft in a rotationally fixed manner,
the first coupling half (202) and the second coupling half (102, 302, 402) being movable toward one another;
the second coupling half (102, 302, 402) having at least one displaceable portion (106, 306, 406);
the displaceable portion (106, 306, 406) of the second coupling half being displaceable by the first coupling half (202) when the first coupling half (202) and the second coupling half (102, 302, 402) are moved toward one another;
the displaceable portion (106, 306, 406) of the second coupling half (102, 302, 402) engaging with the first coupling half (202) in a form fit, rotationally fixed connection when the first coupling half (202) and the second coupling half (102, 302, 402) are moved toward one another; and
the displaceable portion (106, 306, 406) of the second coupling half is displaced primarily in a radial direction.

7. The coupling according to claim 6, wherein a restoring force acts on the displaceable portion (106, 306, 406), and the restoring force acts against the displacement of the displaceable portion (106, 306, 406) of the second coupling half (102, 302, 402).

8. The coupling according to claim 7, wherein the second coupling half (102, 302, 402) is designed as one piece, and an area (206) of the first coupling half (202) elastically deforms the second coupling half (102, 302, 402) during the displacement of the displaceable portion (106, 306, 406).

9. The coupling according to claim 6, wherein the second coupling half (102, 302, 402) has a groove (104) and a fitting key (106) is inserted into the groove (104 and the fitting key (106) forms the displaceable portion of the second coupling half.

10. A second coupling half (102, 302, 402) of a coupling for use with a the first coupling half (202), the second coupling half (102, 302, 402) comprising:
the second coupling half (102, 302, 402) being connected to a second shaft in a rotationally fixed manner,
the first coupling half (202) and the second coupling half (102, 302, 402) being movable toward one another;
the second coupling half (102, 302, 402) having at least a displaceable portion (106, 306, 406);
the displaceable portion (106, 306, 406) of the second coupling half being displaceable by the first coupling half (202) when the first coupling half (202) and the second coupling half (102, 302, 402) are moved toward one another;
the displaceable portion (106, 306, 406) of the second coupling half (102, 302, 402) engages with the first coupling half (202) in a form fit, rotationally fixed connection when the first coupling half (202) and the second coupling half (102, 302, 402) are moved toward one another; and
the displaceable portion (106, 306 406) of the second coupling half is displaced primarily in a radial direction.

11. A coupling for coaxially connecting a first shaft with a second shaft, the coupling, the coupling comprising:
first and second coupling halves,
the first coupling half being rigidly connected to the first shaft to prevent relative rotation therebetween,
the second coupling half being rigidly connected to the second shaft to prevent relative rotation therebetween,
the first coupling half and the second coupling half being axially slidable with respect to one another;
the second coupling half having a plurality of radially displaceable members;
the plurality of radially displaceable members of the second coupling half being radially displaceable by the first coupling half when the first coupling half and the second coupling half axially slide toward one another; and
the plurality of radially displaceable members of the second coupling half are engagable with the first coupling half, when the first coupling half and the second coupling half axially slide toward one another, to form a rotationally fixed connection therebetween.

12. The coupling according to claim 11, wherein
the first coupling half is cylindrical and has an inner surface with a plurality of axially extending recesses;
the second coupling half has an outer surface with a plurality of grooves, each of the plurality of grooves receives one of the plurality of radially displaceable members, and the second coupling half is axially slidable within the first coupling half; and
the plurality of recesses of the first coupling half receive and engage the plurality of radially displaceable members to rotationally fix the first and the second coupling halves to one another when the first coupling half and the second coupling half are rotationally aligned with respect to one another in at least one rotational position and the second coupling half is received within the first coupling half.

13. The coupling according to claim 11, wherein
the first coupling half is cylindrical and has an inner surface with a plurality of recesses that are circumferentially spaced from one another about the inner surface and axially extend along the inner surface;
the second coupling half has an outer surface with a plurality of grooves that are circumferentially spaced from one another about the outer surface;
each of the plurality of grooves in the outer surface of the second coupling half receives a respective one of the radially displaceable members, the plurality of radially displaceable members are elastically biased in a radially outward direction such that, when the second coupling half is slidably received within the second coupling half and based on a rotational orientation of the first coupling half with respect to the second coupling half, the plurality of radially displaceable members of the first coupling half either:
abut against the inner surface of the second coupling half thereby enabling relative rotation between the first coupling half and the second coupling half, or
are received within the plurality of recesses in the first coupling half thereby connecting the first coupling half and the second coupling half in a rotationally fixed manner to prevent relative rotation therebetween.
